(19) United States
(12) Patent Application Publication
(10) Pub. No.: US 2002/0050045 A1
(43) Pub. Date: May 2, 2002

(54) Method for disassembling different elements

(76) Inventors: Joseph David Chiodo, Egham (GB); Eric Billet, Egham (GB)

Correspondence Address: WATTS, HOFFMANN, FISHER & HEINKE CO., L.P.A., Ste. 1750, 1100 Superior Avenue, Cleveland, OH, 44114, US

(21) Appl. No.: 09/994,337

(22) Filed: Nov. 26, 2001

Related U.S. Application Data
(63) Continuation of application No. 09/319,857, filed on Aug. 19, 1999.
Application No. 09/319,857 is a 371 of international application No. PCT/GB97/03392, filed on Dec. 9, 1997.

(30) Foreign Application Priority Data
Dec. 9, 1996 (GB) 9625539.3

(51) Int. Cl. B23P 11/02; A44B 21/00

(52) U.S. Cl. 29/426.5; 29/447; 24/602

(57) ABSTRACT

An invention directed to the partial or whole disassembly of products. An article includes a first and second portion fastened together by a releasable fastener device. The releasable fastener device includes shape memory material and is in the form of a female element threadedly engaged with a complementary male element through a first threaded engagement region of the shape memory material provided on one of the elements and a second threaded engagement region provided on the other element. The releasable fastener device is operative upon shape transition to change the cross-sectional shape of the first threaded engagement region to radially move the first threaded engagement region clear of the second threaded engagement region so as to release the threaded engagement between the male and female elements and leave the male element free to withdraw from the female element without having to be unscrewed therefrom.

This invention relates to the partial or whole disassembly of products. The invention is particularly suitable for use in products which require easy disassembly, for example, for recycling at the end of product life, but it is not limited exclusively to this.

New environmental legislation has been proposed which will make it obligatory for manufacturers of at least certain types of product to provide recycling of part or whole of the product at the end of the product's life. One industry where this will have a major impact is vehicle manufacture. Another industry of importance is electronics product manufacture (for example, televisions, computers, and white goods, etc.).

Strict rules also need to be applied for the safe disposal of parts of a product which contain toxic or potentially hazardous material. For example, in televisions, high voltage components such as the line output transformer contain potentially hazardous insulation and arc quenching material, printed circuit boards are often coated with a flame retardants, and cathode ray tubes contain barium and lead. Such parts need to be isolated from each other according to the types of hazardous material present, and disposed of safely.

Recycling and disposal techniques are being developed, but a significant cost factor in the processing of virtually all products is the disassembly of the product before the component parts can be sorted for re-use, material re-claiming, material disposal, etc. It is possible to break apart a product destructively, but certain valuable re-usable components may then be damaged. In general, it is far more desirable to disassemble at least some of a product in a non-destructive manner, so that ft component part are less likely to be damaged, and are easier to sort.

A product can be disassembled manually, for example, by undoing retaining screws or clips manually or, in the case or electronic circuit board recycling, manually desoldering certain components from the circuit board. However, such a process is expensive, because it is slow and also labour intensive. Furthermore, when manually desoldering an integrated circuit which has a large number of connecting legs, it is difficult to melt the solder on all legs simultaneously. If heat is applied for too long, irreparable heat damage can result

Recently, automated robotic disassembly has been proposed. In such a process, robots or other automated machinery are used to disassemble products and, in the case of electronic products, to desolder or extract key components such as valuable integrated circuits. However, before a product can be processed in this way, the machinery first has to be programmed with information about the shape and size of the product, the position of each fastening to be unscrewed or uncoupled, the size and shape of the electronic circuit board, the position on the circuit board of each component, and the solder positions for each component. Furthermore, the machinery needed to manipulate the product accurately, and to perform the disassembly operation is very expensive. Such automated disassembly is only practical for a run of a large number of identical products. It is not cost effective for collections of individual, different products.

The present invention has been devised bearing the above problems in mind.

A first aspect of invention is to provide shape memory material in a product or article for assisting at least partial disassembly of the product by triggering shape transition of the shape memory material.

With such an arrangement, shape transition of the shape memory material can be used to give the product an active or self disassembly capability.

For example, one of more fasteners may be made of shape memory material which, upon transition, changes shape to release the fastener. In another example, the shape memory material may be employed as a defastener which, upon transition, changes shape to actively move one part away from another.

The invention can enable disassembly of one or more products without the difficulty of having to locate, and unscrew, fasteners such as screws. Instead, it is necessary simply to activate the shape memory material in each product. Therefore, the invention also provides a method of assembling a product which includes such shape memory material, and further a product or article which includes the shape memory material.

Another more detailed aspect of the invention is to provide shape memory material in a product which, upon shape transition, changes shape either to urge separation of a first part or portion away from a second part or portion, or to trigger such active separation. In one form, the shape memory material can produce a dynamic force sufficient to separate casings, sub-assemblies and components with which it may be used.

The shape memory material may, for example, be a discreet element having any desired form. Particularly preferred forms include annuluses or coils which, upon shape transition, expand or lengthen in a generally axial direction, elongate members such rods which can bend, or unbend, to some extent to generate a separation force, and members which can change their cross-sectional shape to generate a separation force. It is emphasised that these are merely examples.

This aspect of the invention is advantageous because it can actively separate or urge apart portions or parts of an article upon disassembly, instead of merely releasing the attachment of the parts. Such active movement of the parts away from each other can considerably simplify the sorting of different parts, particularly in automated machinery. It is much easier to provide automated machinery to collect different parts and components after active separation than it is to try to control automated machinery to perform each unfastening and separation operation as in the prior art.

Such an arrangement is particularly suitable for self-disassembly or self-opening of parts of a housing of a product, or for removal of sensitive parts which might otherwise be difficult to remove.

For example, in a preferred embodiment, one or more shape memory elements are arranged within a case which comprise front and rear case shells held together by snap fit connections. Upon transition, the shape memory element can apply a force to the case parts to overcome the snap fit connection, and to force the front and rear case shells apart.

In another preferred embodiment, a shape memory element can be fitted between an integrated circuit component and a socket or holder into which the integrated circuit is pressed into position. Upon transition, the shape memory element can generate sufficient force to at least partly lift the integrated circuit out of the socket or holder, to facilitate removal of the integrated circuit. Preferably, the shape memory material is arranged to completely separate the integrated circuit from the holder, so that the integrated circuit is free to be grabbed or otherwise collected.

In a yet further embodiment, the shape memory material can be used to shear first and second portions which are integrally coupled. For example, the first and second portions may be respective walls of a housing or case which, upon disassembly, are broken apart to form generally flat case sections. Such sections may be easier to handle and store than the case when whole.

In a further related aspect, the invention provides a releasable fastening element configured to engage or grip another element, at least a portion of the releasable element for engaging or gripping the other element comprising shape memory material which upon transition changes shape to release the other element.

Preferably, the releasable element is configured to mechanically engage the other element and, upon shape transition, is operable to change shape to release or relax the mechanical engagement. For example, the releasable element may be an element which, in normal use, is under compression or tension and, upon transition, changes shape to relax the compression or tension.

In one form, the releasable element may be in the form of a sleeve or sleeve liner for threadedly receiving a screw or bolt. In normal use, the sleeve can maintain firm radial compression engagement with the screw or bolt to achieve a strong and reliable fastening. In one form, the sleeve is oval in cross section to achieve compression. Upon shape transition, the releasable element may, for example, become enlarged, or relaxed, and thereby release the engagement with the threads of the screw or bolt. Alternatively, the releasable element may be in the form of a screw, bolt or other threaded member for threaded engagement within an opening.

In an alternative form, the releasable element may comprise a band or strap which, in normal use, extends over, or around, another part, such as a circuit board or module or sub-assembly, to hold it in position. Upon transition, the releasable element may lengthen or otherwise change shape to release the part being held.

In a further alternative form, the fastener may comprise an opening or mouth for receiving a projection, the shape memory material being operative upon transition to change the shape of the mouth or opening to grip or release the projection.

In a yet further alternative form, the fastener may comprise a jaw, or a retainer, and the shape memory material being operative upon transition to change the shape of the jaw or retainer to release a hold on another part.

A closely related aspect of the invention is to disassemble a product at least partly by activating shape transition of shape memory material within the product.

The shape memory material may be activated by any suitable means, preferably a means for subjecting the material to a temperature change above, or below, a transition temperature. For example, for elevated temperatures, heat may be supplied using hot gas (e.g. air), steam, or electrical current. The activation means may, for example, be in the form of a heated room or enclosure, or an iron for supplying heat, a hot air blower or jet, means for passing an electric current through, or inducing an electrical current in (e.g. by magnetic or microwave interaction), the shape memory material (or through or in an element in thermal contact therewith).

In the case of a temperature drop, heat may be extracted by using cold gas, or evaporation of a refrigerant. The activation means may, for example, be in the form of a cool room or enclosure, a cooling probe having a cooled tip, a cold air blower or jet, or means for introducing a refrigerant (such a liquid nitrogen) to at lease the vicinity of the shape memory material.

It will be appreciated that any number of different products can be disassembled using this technique. It is not necessary to know and physically locate the exact position of each fastener of a product. Instead, it is simply necessary to know the transition temperature(s) of the shape memory material(s) within the products, to enable the material to be “activated”.

A further aspect of the invention is to provide different elements of shape memory material in a product for assisting disassembly, the different elements having different transition temperatures at which shape transition occurs. With this aspect, sequential disassembly of the product is facilitated. For example, by subjecting the product to a first temperature, a first shape memory element can be triggered to cause disassembly or release of a first part. Thereafter, by subjecting the product to a more extreme (higher or lower) second temperature, a second shape memory element can be triggered to cause disassembly or release of a second different part.

Therefore, different parts of a product can be disassembled in sequence at different times, simply by increasing or decreasing the temperature(s) progressively. This is particularly advantageous in products where disassembly is required in an ordered sequence, for sample, to facilitate simpler handling by automated machinery. Alternatively, it may be applicable to parts, such as electronic components, using shape memory material having a shape transition temperature associated with the type of component. For example, all valuable integrated circuits may be mounted using shape memory material having a first transition temperature, less valuable integrated circuits and other semiconductors mounted using shape memory material having a second transition temperature, transformers mounted using shape memory material having a third shape transition temperature, keyboard components mounted using shape memory material having a fourth transition temperature, etc. Additionally, parts made of hazardous material may be mounted using shape memory material having a transition temperature associated with the hazardous material present, so that all parts including the same hazardous material can be disassembled and collected together.

Accordingly, a yet further aspect of the invention is to disassemble a product sequentially by triggering shape transition of at least some different shape memory material elements in the product at different times.

It will be appreciated that the difference between shape memory material and other materials is that the shape memory material can suddenly change shape or form when it is activated so to do, for example, by the temperature exceeding, or dropping below, a predetermined transition temperature for the material. Of course, it is well known that conventional metals will expand on heating, or that conventional plastics will relax or flow upon heating. However, the advantages of using shape memory material instead of conventional metal or plastics are that:

(a) the material can be “trained” to adopt any desired change of shape at transition, not merely expansion or relaxation;

(b) the change of shape at transition can be much greater, and more forceful, than that obtained by the relatively small expansion or relaxation by heating of conventional materials;

(c) the temperature at which transition occur can be determined accurately (for example, by varying the composition of the shape memory material) so that no change of shape will occur at normal temperatures of the product. Generally, the transition temperature can be predetermined as desired anywhere in the rant 50° C. to 150° C., depending on the composition and the nature of the material; and

(d) the shape transition can be made to occur either when the temperature exceeds a predetermined threshold, or when the temperature drops below a threshold. For example, a shape memory material can be trained to adopt a first shape in a first temperature range below the transition temperature, and a second shape in a second temperance range above the transition temperature. If the transition temperature is greater than normal ambient temperatures, then the first shape will be adopted when under normal ambient conditions, and it will be necessary to heat the material to achieve the second shape. On the other hand, if the transition temperature is below normal ambient temperatures, then the material will adopt the second shape under normal ambient conditions, and it will be necessary to cool the material to achieve the first shape.

Commonly known memory shape alloys include zinc-copper-aluminium alloy (Zn—Cu—Al) and nickel-titanium alloy (Ni—Ti). The former alloy is obtainable very cheaply, and its shape transition is generally reversible repeatedly. For example, upon heating, the alloy may be trained to expand to a predetermined shape and, upon cooling, the alloy will return to its original shape, and this temperature cycle may be repeated a number of times. The latter alloy is more expensive, but has an advantage of better elect conductivity than the former. It also has a non-reversing characteristic, i.e. the alloy does not always return to its original shape after transition, but is reversible provided that the shape change is not too severe. Metal alloys have an advantage that they can produce considerable forces upon shape transition, although the magnitude of shape change is limited.

New shape memory plastics/polymers are also obtainable, for example. materials based on polyurethanes. Such materials can easily be moulded to any desired shape. It may also be convenient to mould a shape memory polymer element as an integral part of a plastics case.

Shape memory polymers have a characteristic that they are generally rigid in form up to a transition temperature, above which they lose shape integrity and relax depending on any forces present. Upon cooling, the polymer can return to its original rigid shape and form in the absence of external forces. Alternatively, if an external force is applied to change the polymer shape while the polymer is in its rubber state, and if the force is maintained during cooling, the material will adopt the new shape as its stable shape when cold.

Shape memory materials have previously been used as actuator elements. for example, in releasable couplings. Reference is made to the arrangements disclosed in patent publications Nos. U.S. Pat. No. 5,095,595, U.S. Pat. No. 5,160,233, U.S. Pat. No. 5,312,152, U.S. Pat. No. 5,366,254, and WO-A-91/04433. However, none of these specifications describes or suggests the use and structure of memory shape materials of the present invention.

Embodiments of the invention arm now described by way of example only, with reference to the accompanying drawings, in which:

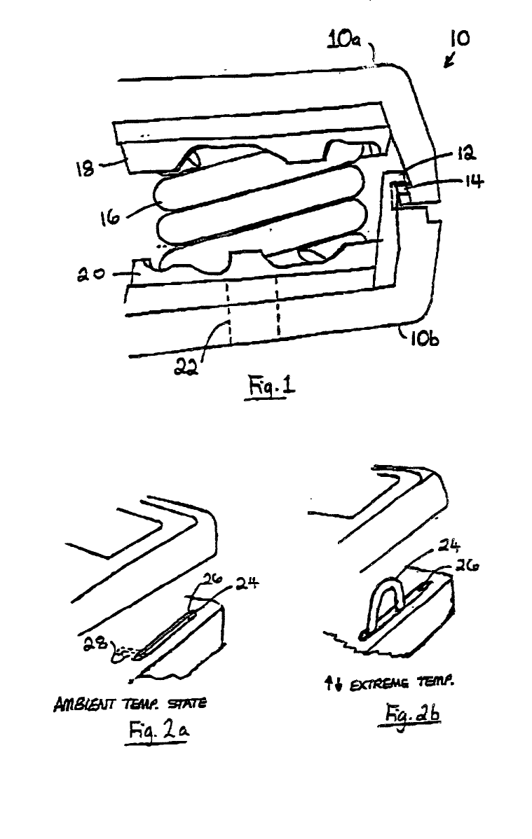

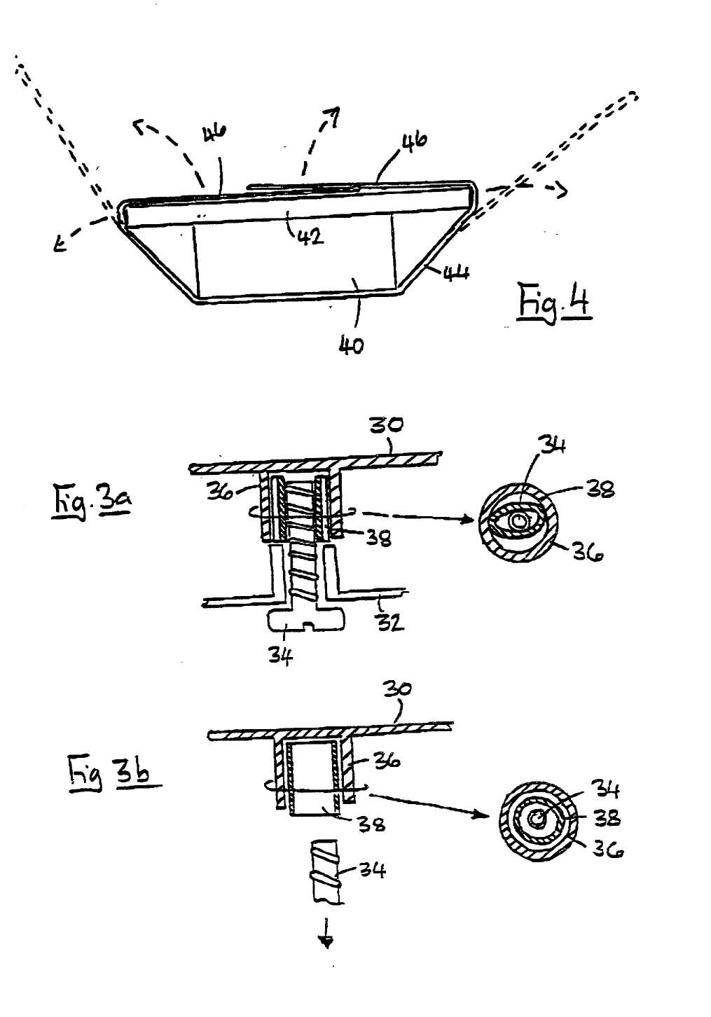

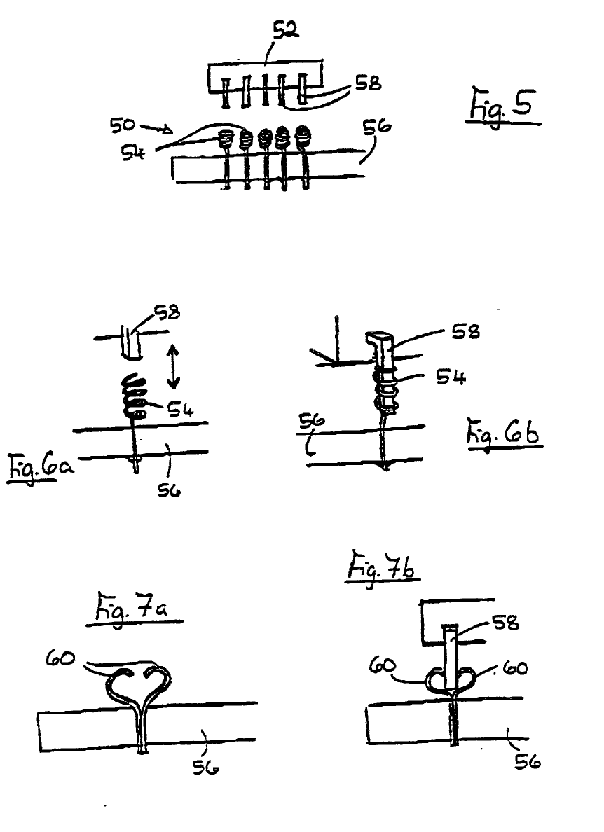

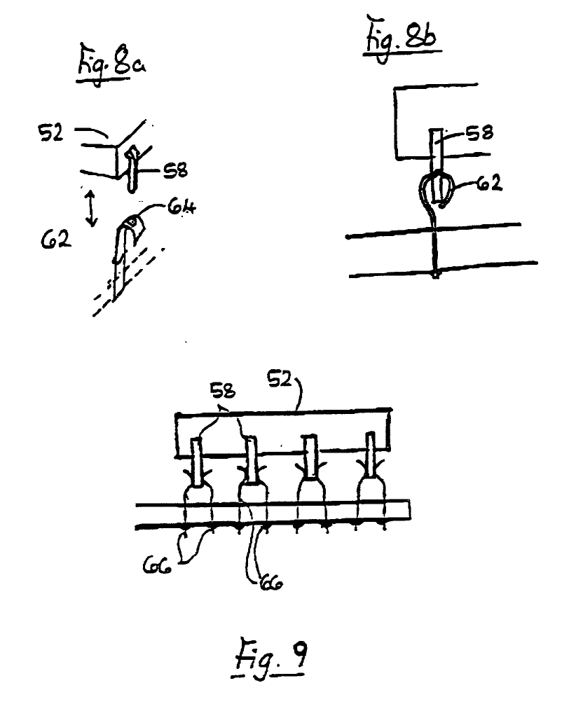

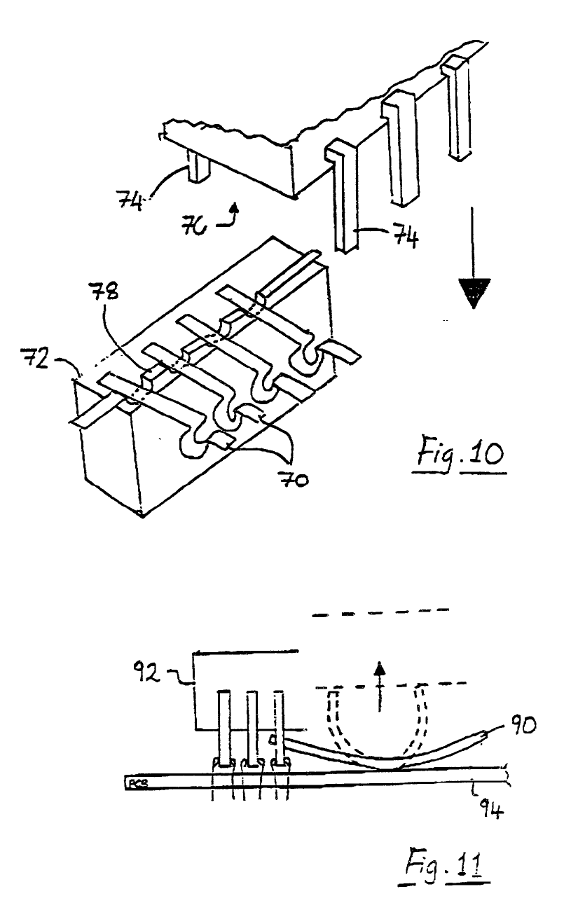

FIG. 1 is a side section through a first case de-fastener;

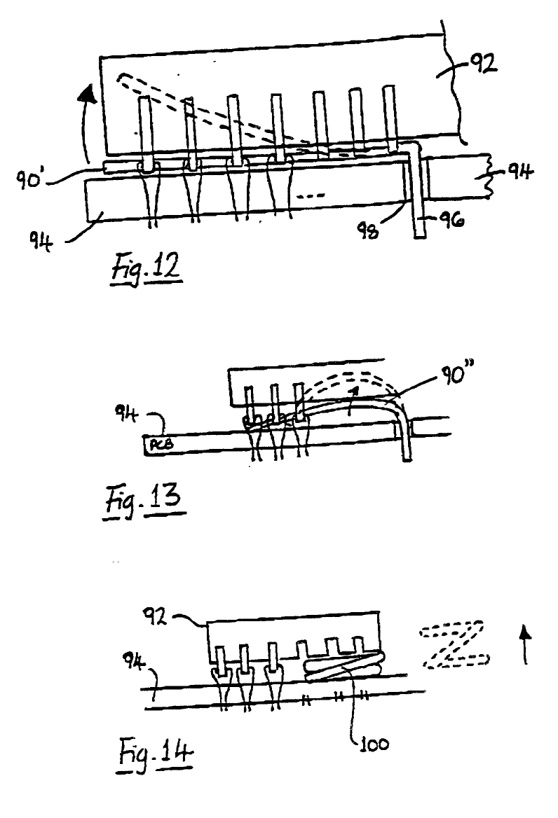

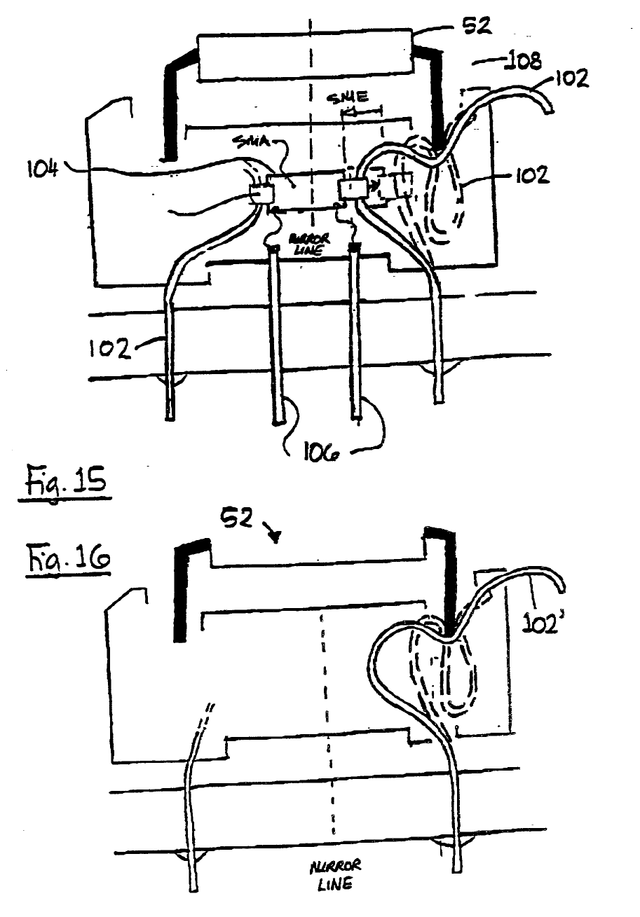

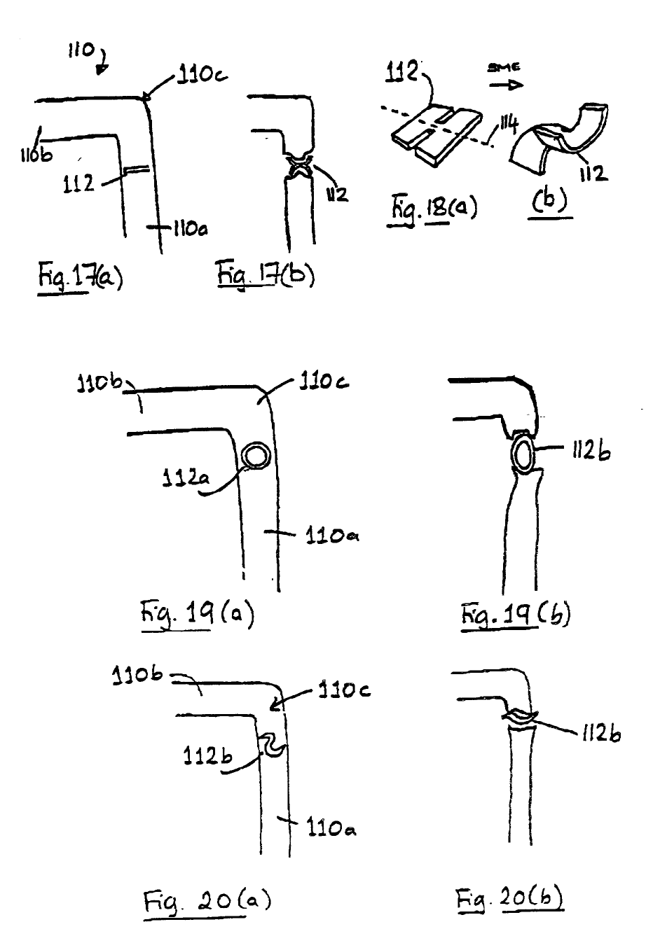

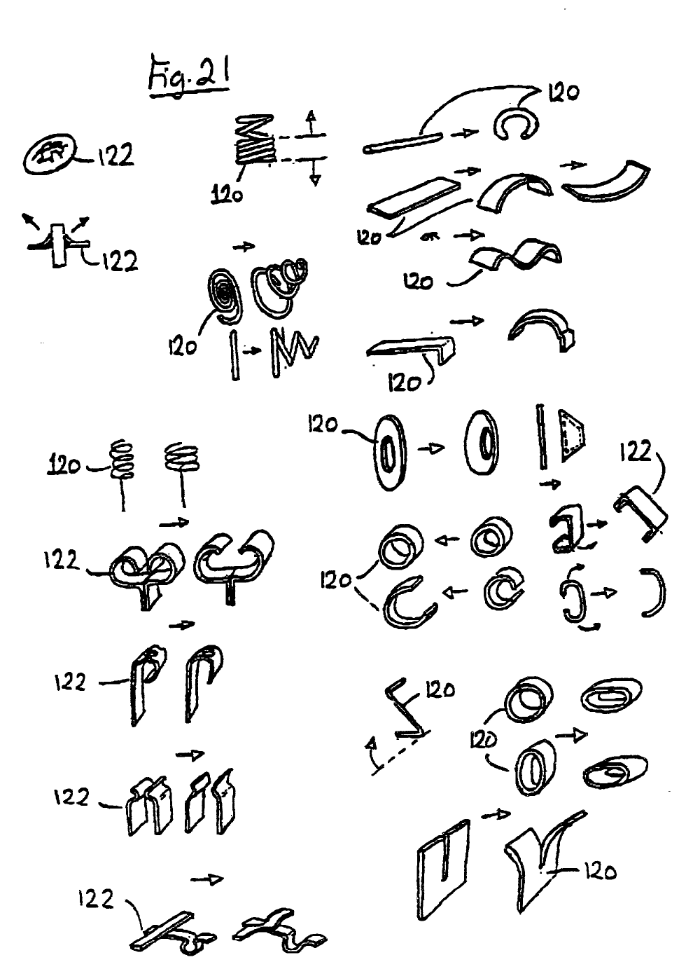

FIGS. 2a and 2b are schematic drawings of a second case de-fastener;

FIGS. 3a and 3b are schematic drawings of a third case fastener;

FIG. 4 is a schematic view of a module holder;

FIG. 5 is a schematic drawing of a first electronic component holder;

FIGS. 6a and 6b are enlarged partial views of a detail of FIG. 5;

FIGS. 7a and 7b are schematic drawings of a second electronic component holder;

FIGS. 8a and 8b are schematic drawings of a third electronic component holder;

FIG. 9 is a schematic drawing of a fourth electronic component holder;

FIG. 10 is a schematic view of a modified self-heating form of electronic component holder;

FIG. 11 is a schematic view of a fist electronic component remover;

FIG. 12 is a schematic view of a second electronic component remover;

FIG. 13 is a schematic view of a third electronic component remover;

FIG. 14 is a schematic view of a fourth electronic component remover;

FIG. 15 is a schematic view of an alternative component holder;

FIG. 16 is a schematic view of a further alternative component holder;

FIGS. 17a and 17b are schematic views of a frangible wall with shape memory material;

FIGS. 18a and 18b illustrate the shape memory element used in the arrangement of FIG. 17;

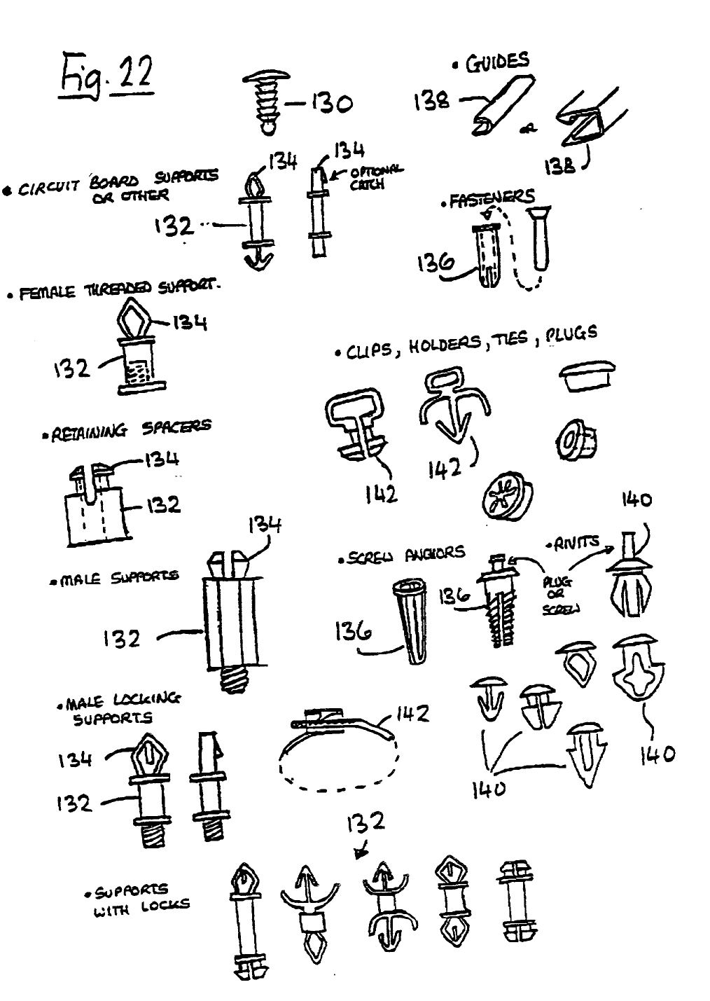

FIGS. 19a and 19b arm schematic views of alternative frangible wall arrangement;

FIGS. 20a and 20b are schematic views of a further hangible wall arrangement;

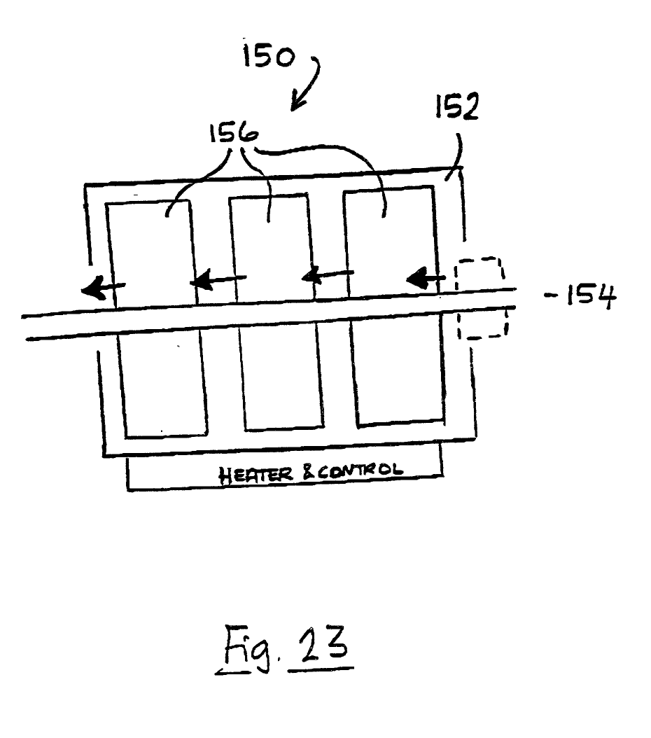

FIG. 21 illustrates a range of shape memory alloy elements;

FIG. 22 illustrates a range of shape memory polymer elements; and

FIG. 23 is a schematic view of a processing apparatus for triggering disassembly.

Referring to FIG. 1, a case 10 of a slim article, such as a calculator, consists of an upper or front shell 10a which is joined to a lower or rear shell 10b by a snap fit connection in the edge wall of the case. The snap fit connection is formed by a lug 12 projecting from the rear shell 10b which locates behind an inwardly directed rim 14 of the front shell 10a.

Positioned close to the edge wall is a helical-spring-shaped active separator or defastener 16 of a shape memory material. In this embodiment, the defastener is made of shape memory alloy, such as Cu—Zn—Al. The opposite ends of the defastener 16 are seated in collars 18 and 20 which are formed integrally on the inner faces of the front shell 10a, and the rear shell 10b, respectively.

The defastener 16 has been trained to change shape between a compressed state (shown in FIG. 1) at normal room temperature, and an expanded state, in which the defastener lengthens longitudinally (in a similar manner to a spring), to approximately double its compressed axial length. The material can be trained in the usual manner by forcing the material to adopt the desired shapes in the temperature ranges below and above the transition temperature for the material. Such a technique is known in the art, and so no further elaboration is needed in this description.

During normal use, at ambient temperatures, the defastener automatically adopts its compressed state. In this state, the defastener applies no, or very little, force on the upper and lower case shells 10a, 10b. The snap fit connection holds the front and rear shells in their assembled condition and provides a strong, secure, connection. The collars 18 and 20 hold the defastener 16 in position.

At the end of the article's life, when it is desired to recycle the article, it is first necessary to disassemble the front and rear case shells 10a, 10b to remove the internal components of the calculator. In order to do this, the article is subjected to an elevated temperature (in this embodiment) greater than the transition temperature of the defastener material, to cause the defastener to change shape to its elongated shape. As the defastener begins to expand longitudinally, it bears against the opposed inner faces of the front shell 10a, and rear shell 10b, urging them apart. The force developed by the defastener is greater than the threshold which the snap fit connection can sustain, and within a short space of time, the force overcomes the engagement of the snap fit connection, and springs the front and rear case shells apart. The collars 18 and 20 prevent the spring from accidentally twisting out of position while the large force is being developed to overcome the snap fit connection.

If desired, one or more openings 22 may be provided to increase the rate of heat transfer to the defastener 16 from outside the case. This may be advantageous if the case does not include its own ventilation openings.

Although only one defastener 16 is illustrated in the partial section of FIG. 1, it will be appreciated that a plurality of such defastener elements may be used at different spaced positions around the edge wall of the case. For example, for a rectangular case, a separate defastener element may be used in each corner. Additional defastener elements may also be used intermediate the corners.

It will be appreciated that the defastener described in this embodiment can provide quick and reliable disassembly of the case parts with minimum labour, and minimum damage to the case parts and to the components inside the case. Particularly where a plurality of defastener elements are used, the defasteners can be activated substantially simultaneously, by the application of heat, which can provide much more rapid disassembly than a conventional arrangement in which a number of screws have to be located and unscrewed individually.

In this embodiment, a helical-spring-shaped defastener 16 has been used. The helical-coil shape can develop very high forces for the size of the defastener, and can develop large movement. Typically, for a defastener made of Cu—Zn—Al, having a diameter of approximately 1 cm and a longitudinal (compressed) length of around 1/2 cm, a defastening force of between 1 and 10 Newtons or more can be developed at transition.

If less force is required, or if less space is available, then it may be more convenient to use the arrangement illustrated in FIG. 2. In this arrangement, a rod shaped defastener 24 replaces the coil-shaped defastener 16. The rod defastener 24 is received within a channel shaped recess 26 in the wall of the rear shell 10b (see FIG. 2a). In its ambient temperature state, the defastener forms a straight rod. However, when heated above the transition temperature, the defastener 24 adopts a U-shape (or inverted U-shape as illustrated in FIG. 2b), and lifts itself out of the recess 26, thereby forcing apart the front shell 10a and the rear shell 10b in a similar manner to that described above.

As shown in phantom in FIG. 2a, the defastener 24 may be formed with an anchor, for example, a transverse leg 28, to ensure that the defastener is orientated correctly in the recess 26 to bend in a generally upright plane. It will be appreciated that if the defastener is incorrectly orientated (for example, rotated through 90°, then the bending at transition may occur in a horizontal plane, which would produce little or no separation force. The defastener rod 24 could also have a special cross-sectional shape (for example, flat rectangular) to aid correct orientation in the recess 26.

Referring to FIGS. 3a and 3b, a screw threaded, fastener/defastener is illustrated. In this embodiment, two part, 30 and 32 (such as front and rear case shells) are secured together by one or more screws 34 which each engage in a respective sleeve 36 integrally moulded on the inner face of the front case shell 10a. A liner 38 is received within the sleeve 36 and provides the engagement surface into which the thread of the screw 34 bites when the screw is tightened (see FIG. 3a).

The liner 38 consists of a tubular portion of memory shape material, in this embodiment memory shape polymer. The material is trained to adopt a firm or slightly oval “compression” state in which it radially grips the thread of the securing screw 34 in a first temperature range corresponding to ambient temperature. In a second temperature range (for example, above a predetermined transition temperature, say 50° C., the material loses shape integrity and relaxes to a more rounded cross sectional shape. In this loose “loose” state the liner releases engagement of the thread of the screw 34.

Therefore, during normal ambient conditions, the liner 38 provides a firm gripping surface into which the thread of the screw 34 bites to achieve a strong and secure fastening. If desired, the screw can be unscrewed and replaced in the normal way, for example, in the course of repair or maintenance. The polymer liner 38 is about as strong as conventional plastics, and can provide good grip even when the screw 34 is unscrewed and retightened a number of times, provided that the screw 34 is not overtightened (which could cause conventional thread stripping damage to the liner).

To disassemble the article, for example at the end of its life, the article is subjected to a temperature greater than the transition temperature. The liner 38 expands to release the screw 34, and hence allows the front and rear case shells 30 and 32 to be separated (see FIG. 3b). Although only one screw is illustrated in the partial views of FIGS. 3a and 3b, it will be appreciated that a plurality of screws 34 and liners 38 may be used in practice to secure the case shells 30 and 32 at number of different locations. These fastenings can all be released substantially simultaneously by the application of heat, thereby providing much simpler and faster disassembly compared to having to unscrew each screw 34 individually.

In the above embodiment, the shape memory material is provided in the form of a liner, so that it can be fitted easily to a sleeve which is integral with, or part of, another item. In use, the oval liner is an interference fit within the sleeve, and is locked in position by the additional pressure from the screw 34. However, it will be appreciated that in other embodiments, the sleeve itself may be formed of shape memory material.

Alternatively, instead of the socket fastener part being of shape memory material, the screw or spigot part way be made or include shape memory material. In such case, the material would be trained to change shape between a firm, radially tensioned form in which it grips a hole into which it is insert, to a relaxed, untensioned form in which it can be withdrawn loosely from the hole. In the firm tensioning form, the screw may, for example, have an oval cross-section which relaxes to a round section above its transition temperature.

The embodiment illustrated in FIGS. 3a and 3b functions simply to release the two parts 30 and 32, rather than to urge the two parts away from each other. Therefore, this arrangement may be suitable for applications in which the lower part is permitted to drop clear of the upper part once released. However, if positive separation is desired, then one or more springs may be provided to urge the parts 30 and 32 apart. During normal use, the springs would be held in a compressed state by the securing screws 34. Alternatively the shape memory defastener illustrated in FIGS. 1 and 2 may be used in combination with the shape memory screw fastener of FIGS. 3a and 3b to provide positive separation.

FIG. 4 illustrates a further embodiment of fastener. In this embodiment, a module or sub-assembly 40, such as a keyboard unit is held in position on a supporting structure 42 by means of a securing strap 44. The strap is made of shape memory material, in this embodiment shape memory polymer. As illustrated by the full lines in FIG. 4, the polymer is trained to adopt a first shape at ambient temperatures, in which the strap is wrapped around the module and the support, with the ends 46 of the strap 44 overlapping each other, such that the strap extends tightly around the module 40.

In normal use under ambient temperature conditions, the strap 44 retains the module 40 securely in position. In order to disassemble the module from the supporting structure, the temperature is raised above the shape transition temperature, to cause the polymer to relax, and to lose shape of form integrity. In such state, the strap 44 is no longer able to bear the weight of the of the module 40, and unwraps under the weight to allow the module to fall clear.

In this embodiment, the strap is made of shape memory polymer, and relaxes at an elevated temperature. Alternatively, the strap could be made of shape memory allow (for example in security applications to prevent removal of expensive integrated circuits from, for example, a computer board) which is trained between a closed “wrapped” memory state and a loose or “unwrapped” memory state.

Referring to FIGS. 5, 6a and 6b, the invention may also be used to mount electronic components, such as integrated circuits, in a self-releasing manner. In FIG. 5, a socket 50 for an integrated circuit 52 is formed by a plurality of contacts 54 of electrically conductive memory shape alloy each in the shape of a small helical coil. The lower end of each contact 54 passes through a respective opening in a printed circuit board 56, and can be soldered to a track of the printed circuit wiring (not shown). Each contact coil 54 is dimensioned to receive a leg 58 of the integrated circuit 52.

At ambient temperatures, the helical coils each adopt a tight configuration to grip the legs 58, to establish an electrical connection to the integrated circuit through the legs 58 and to lock the legs inside the coils. The integrated circuit 56 is thereby firmly held in position on the printed circuit board.

The shape memory material is also trained at an elevated temperature (or at a lowered temperature, as desired) to expand in diameter, and “unwind” sufficiently to release the legs 58 and/or allow leg insertion. Therefore, in use, in order to fit the integrated circuit 52 to the socket 50, the socket is first warmed (or cooled) to trigger the shape memory contact coils to their expanded “open” condition. The integrated circuit can easily be placed in the socket with zero insertion force being required. As the socket returns to normal temperature, and the temperature again crosses the transition temperature, the shape memory coil contacts are triggered to return to their tightened condition.

In order to remove the integrated circuit 52, it is necessary simply to heat (or cool) the socket 50 to again trigger shape transition of the shape memory contact coils 54 to their expanded state. In this state, the integrated circuit is released, and can be easily removed (or can drop out of the holder under gravity if the circuit board 56 is turned upside down).

It will be appreciated that this embodiment provides an extremely simple, compact, and yet extremely effective, zero insertion force socket, which does not require any direct mechanical interaction to release the integrated circuit. The self-releasing, temperature-dependent characteristic enables the integrated circuit to be inserted and removed in a simple manner without risk of damage to the integrated circuit. The shape transition will occur at roughly the same time in all of the contact coils 54, so that prolonged heating (or cooling) is unnecessary.

The shape memory material used for the contact coils 54 is preferably Ni—Ti, as this material has good electrical conductivity. The material can be used for reversible shape transitions amounting to dimensional changes of up to 5 or 10%. which is adequate for this application.

Although not illustrated in FIG. 5, the contact coils 54 may, if desired, be mounted within a socket housing, for example, a dual-in-line plastics housing, for accurate pin alignment.

Referring to FIGS. 7a and 7b, an alternative shape of contact 54 is shown. In this arrangement, the contact is in the form of a looped butterfly shape, and the loops 60 are trained to move between an open position (illustrated in FIG. 7a) in which the gap between the loops 60 is sufficient to allow the leg 58 of an integrated circuit to be removed/inserted, and a closed position (illustrated in FIG. 7b) in which the loops 60 approach each other to grip the leg 58 firmly.

Referring to FIGS. 8a and 8b, a further alternative shape of contact 54 is shown. In this arrangement, the contact is in the form of a finger 62 have a hole 64 therethrough for receiving the leg 58 of the integrated circuit. The finger 62 is trained to change shape between a first state (FIG. 8a), in which the hole 64 is enlarged to allow insertion/removal of the leg 58, and a second state (FIG. 8b) in which the finger contracts by folding, to reduce the effective size of the hole 64, and hence grip the leg 58.

Referring to FIG. 9, a yet further alternative shape of contact 54 is shown. In this arrangement, the contact is in the form of a pair of upstanding lugs 66 which may be joined at their base by an integral web, or be individually mounted. The lugs 66 are trained to change shape between a first state in which the lugs are separated by a gap sufficiently large to allow insertion and removal of the leg 58, and a second state in which the lugs are biased towards each other to grip the leg 58.

FIG. 10 illustrates a further design of integrated circuit socket, which operates in a similar manner to that described above, but which includes electrical terminals for passing a heating current to effect the shape transition. The socket includes a plurality of cantilever contacts 70 which extend laterally from a support 72 of electrically insulating material. The free ends of the contacts 70 are formed with cups for receiving the legs 74 of an integrated circuit 76. The contacts 70 are made of electrically conductive shape memory alloy (such as Ni—Ti) and are trained to change shape between a first state in which the cups are substantially “open” to allow removal/insertion of the integrated circuit, and a second state in which the mouths of the cups are substantially “closed” to grip the legs 74 and establish electrical contact therewith.

Extending over the tops of the contacts 70 on the support 72 is a further electrical conductor strip 78. The purpose of the strip 78 is to generate heat when an electrical current is passed therethrough, to cause shape transition of the contacts 70. In this embodiment, the strip 78 is not made of shape memory material, and is separated from the contacts by a layer of electrically insulating, thermally conducting material. Therefore, the strip does not affect the electrical characteristics of the contacts 70 of the socket, but is able to transfer heat to the contacts 70 to trigger shape transition.

In a modified form, the strip 78 may be made of shape memory material and arranged such that, when at ambient temperature, the strip is clear of the contacts 70, but when heated, the strip 70 deflects downwardly to bear against the contacts 70. With such an arrangement, the strip 78 does not affect the contacts 70 in any way under normal temperature conditions, since it is spaced above the contacts 70. However, when current is passed through the strip 78, it deflects downwardly into contact with the contacts 70, and thus allows heat to be transferred directly to the contacts 70 to trigger shape transition. It will be appreciated that when the strip 78 bears against the contacts 70 it will short the contacts 70 together, but this is unlikely to cause any problem because the electronic circuitry will not, of course, be operative when it is desired to remove or insert the integrate circuit. As illustrated in FIG. 10, the opposite ends of the strip 78 may project beyond the support to provide electrical terminal to which wires may be attached to pass the heating current. Alternatively, the ends of the strip may also be solder to the circuit board so that a heating current can be introduced through the printed circuit.

It will be appreciated that the above embodiments provide zero insertion force/zero removal force sockets which allow a component such as an integrated circuit to be released without mechanical interaction. Upon release, the integrated circuit is not ejected from the socket, but is free to be removed (or to fall out under gravity if the socket is upside down). In the further embodiments of FIGS. 11-13, shape memory material is employed to force the integrated circuit at least partly out of the socket for easier removal.

Referring to FIG. 11, a strip 90 of shape memory alloy, such as Cu—Zn—Al, is positioned between the underside of the integrated circuit 92 and the circuit board 94 (or the base of the integrated circuit socket). The shape memory material is trained to change shape between a normally flat state under ambient conditions, and a curved state at elevated (or cold) temperature conditions. In normal use, the strip 90 does not generate any material forces, and is simply retained in position by suitable stops (not shown) on the circuit board or socket. When the temperature exceeds (or drops below) the transition temperature, the strip 90 begins to transform to its curved shape, thereby applying a force to lift the integrated circuit 92 out of the socket. Such an arrangement may either be used in combination with the shape memory contacts illustrated in the preceding embodiments, or it may be used with conventional resilient metal contacts.

An alternative lifting arrangement is also shown in FIG. 12. In this arrangement, the strip 90′ of shape memory material has one end 96 anchored to the circuit board. In this example, the end 96 is bent over and is secured in an opening 98 through the circuit board 94. In use, upon shape transition, the strip 90 bends away from the board 94, and acts as a cantilever to lift the integrated circuit at least partly out of the socket.

FIG. 13 illustrates a further arrangement similar to that of FIG. 12, except that the strip 90″ is trained to form an inverted U-shape instead of a cantilever shape.

FIG. 14 illustrates a further alternative lifting arrangement in which a helical-spring-shaped element 100 similar to that used in the first embodiment, is positioned between the circuit board and the underside of the integrated circuit 92. The element 100 is trained to change shape between a first axially compressed state (seen in FIG. 13), and an axially elongated shape (shown in phantom) to eject the integrated circuit. The use of a helical element 100 may be particularly suitable for applications where considerable force is desirable to eject the integrated circuit clear of the socket.

FIG. 15 illustrates a further embodiment of an integrated circuit holder. In this embodiment is similar in construction to a conventional dual-in-line integrated circuit holder, and uses conventional terminals 102, for example, of thin copper strip which are bent into a loop shape (shown in phantom in FIG. 15) to provide resilient “sockets” for receiving and making electrical contact with the pins of the integrated circuit. An actuator 104 of shape memory alloy is coupled between the pins on one side, and the pins on the other side. First and second heater contacts 106 provide direct electrical connection to the actuator, to allow an electrical current to be passed therethrough to heat the actuator.

In normal use at ambient temperatures, the actuator 104 adopts an expanded state (shown in Phantom in FIG. 15) in which it applies little or no force to the terminals 102, and allows the terminals 102 to adopt their usual configuration. In order to remove the integrated circuit from the socket, a current is passed through the heater contacts 106 to heat the actuator 104 (or the holder is subjected to an increased external temperature). Upon heating, the actuator contracts (to the position shown in full line) which, in turn, causes inner portions of the copper contacts 102 to be forced inwardly. The profile of the socket case includes a downwardly extending lip 108 which cooperates with the copper contacts 102 to prevent the outer end of the contact from moving inwardly and, in combination with the springiness of the copper contact, this causes the contact to spring upwardly, thereby ejecting the pins of the integrated circuit from the holder.

It will be appreciated that, in this, embodiment, the shape memory material is used as an actuator or engine to trigger movement of other parts. However, in an alternative embodiment illustrated in FIG. 16, the pin contacts 102′ are made of shape memory alloy (Ni—Ti being preferred for its high electrical conductivity). The contacts 102′ are trained to change shape from a folded loop form (shown in phantom) to an a partially unfolded form upon temperature change above or below the transition temperature for the material, to eject the pins of the integrated circuit in a similar manner to that described above.

All of the above embodiments have illustrated separation of two or more distinct parts of a product or article. In the embodiment illustrated in FIGS. 17a and 17b, shape memory material is used instead to shear apart first and second integral portions in a predictable, controlled manner. FIG. 17 shows a case wall 110 typically of plastics material which includes, in this example, a side wall portion 110a integrally coupled to a horizontal wall portion 110b. Embedded within the wall 110 in a connecting corner region 110c is a destructor element 112 of shape memory alloy. As best seen in FIG. 18, the element 112 has a generally “H” shape. Under normal ambient temperature conditions, the element is trained to be flat, as in FIG. 18a. At an extreme high or low temperature, the opposite sides of the element 112 curl, or bend, out of the flat plane, in opposite directions, as shown in FIG. 18b.

Referring to FIG. 17b, when the element 112 is activated by temperature to change to its expanded shape (FIG. 18b), the force exerted shears the connecting corner region 110c of the wall to separate the side wall 110a from the horizontal wall 110a.

Although not shown in FIG. 18, it will be appreciated that the element 112 may be elongate, and consists for example of repeating integrally coupled “H” portions (extended in the direction illustrated by the line 114 in FIG. 18a). Thus, the element may extend along substantially the length of the corner between the two wall portions.

FIGS. 19a and 19b illustrate a further embodiment similar to that above, except that a tubular shape memory element 112a is used. The drawings illustrate the tubular element 112a changing shape from round to oval in a vertical direction, to generate a shearing force in the same direction as the plane of the wall. Alternatively, the element 112a could be arranged to change shape from horizontally oval to vertically oval to achieve this shearing force.

FIGS. 20a and 20b illustrate a further similar embodiment, in which a shearing force is produced in a transverse direction to the plane of the surface.

Referring to FIG. 20a, a shape memory element 112b comprises a generally S-shaped member which, upon shaped transition flattens transversely to cut through the material of the case wall in the corner region 110c, and hence shear the wall.

The element 112b has sharp or tapered ends which tend to wedge apart the two sections 110a and 110b of the wall as the material shears.

In the embodiments of FIGS. 17-20, heat conducting openings or contacts may also be provided to facilitate rapid heating or cooling of the material from outside the case, and thereby reduce the time necessary to supply sufficient heat (or cold) to the shape memory element to trigger shape transition.

The shape memory elements 112, 112a and 112b can be positioned in the wall in any desired way. For example, a hole may be formed in the wall, and the element inserted in the hole after the case has been moulded. Alternatively, the shape memory element may be positioned within a mould prior to moulding, and the case moulded around the shape memory element so that it is an integral part of the case wall.

It will be appreciated that there are numerous designs of fastener which may include shape memory material in accordance with the invention. By way of example only, FIG. 21 illustrates a range of typical fasteners which may be made of shape memory alloy. These include defasteners 120 and releasable grippers 122 (for example for mechanical or electrical use). Similarly, FIG. 22 illustrates a range of typical fasteners which may be made of shape memory polymer. These include ratchet fastener 130, supports and spacers 132 (in which lugs 134 are configured to relax upon shape transition and to release a carried load), threaded plug sockets 136, guides 138 (which are configured to relax and release compression engagement of, for example, a circuit board received with the guide), plugs or rivets 138, and cable fasteners 140.

It will be appreciated that the principles of this invention are not limited to the illustrated examples, and will have many varied applications in a wide range of fields where an inherent self-disassembly characteristic is desired.

In particular, although the examples illustrated have referred generally to electronic products, it will be appreciated that the invention is not limited to this field. The principles of the present invention may be used in any field of assembly/disassembly of a product or article, to at least partially assist disassembly of the product or article. It is expected that a major field of importance will be that of vehicle manufacture, where substantial recycling is possible, but is limited at the moment by the considerable time needed to identify and remove parts from cars, particularly if the fastenings are difficult to access or are difficult to release owing to the presence of dirt or corrosion. In particular, part such as bumpers, interior panels, wiring harnesses, batteries, starter motors, instrument clusters and facias, can all be fastened using shape memory material in accordance with the invention.

The principles of the present invention may also have safety applications, for providing automatic release or disassembly in case of emergency. For example, if a vehicle is involved in a crash, it may be much easier for rescuers to release a victim from the wreckage by triggering release of shape memory material fasteners, for example, to disassemble a door hinge from the main body. Such disassembly can be performed without having to have visible access to the hinge fasteners, and without having to use cutting machinery which may otherwise distress, or physically interfere with, a trapped victim.

FIG. 23 illustrates schematically an apparatus for processing one or more products to perform at least partial self-disassembly. The apparatus 150 comprises a chamber 152 into or through which products are conveyed, for example, on a conveyor 154. The chamber 152 is heated or cooled to a predetermined temperature to trigger release of the shape memory material in the products. Preferably, a temperature gradient is established in the chamber 152 to enable sequential disassembly of different parts of the product which include fasteners, or defasteners which are triggered into shape transition at different temperatures, as the product is conveyed through the chamber 152. If the product is suspended upside down, or uses defasteners which spring apart the disassembled parts, then collection bins 156 may be provided in the chamber 152 below the path of the product for collecting parts as they fall from the products. This is particularly convenient for disassembling a batch of different products, which all use shape memory fasteners or defasteners which trigger at the same temperature for disassembling like parts, such as integrated circuits, transformers, car bumpers, etc.

The aspects of the invention believed to be particularly important have been set out in the appended claims. However, the Applicant claims protection for any novel combination of features described herein, or illustrated in the drawings, irrespective of whether emphasis has been placed on thereon.

Claims:

1. An article comprising shape memory material arranged such that, in use, upon shape transition of the shape memory material, first and second portions of the article are pushed apart by a force exerted between the first and second portions.

2. An article according to claim 1, wherein the shape memory material is operative, upon shape transition, to generate a separation force to urge said first and second portions apart.

3. An article in which shape memory material is provided for assisting disassembly of the article, the shape memory material being operative upon shape transition to exert a force between first and second portions of the article to urge separation of the two portions.

4. An article according to claim 2 or 3, wherein the first and second portions are integral with each other, and the shape memory material is operative to shear a region connecting the first and second portions.

5. An article according to claim 4, wherein the shape memory material is embedded or inserted in the region connecting the first and second portions.

6. An article according to claim 2 or 3, wherein the first and second portions are distinct parts fastened together in assembled relation, and the shape memory material is operative to exert sufficient force to overcome the fastening.

7. An article according to claim 6, wherein the fastening comprises a snap fit connection.

8, An article according to claim 6, wherein the first and second parts are fastened together by welding.

9. An article according to claim 6, wherein the first and second parts are fastened together by adhesive.

10. An article according to any of claims 1 to 9, wherein the shape memory material is provided in the form of an annular element or a helical coil element which, upon shape transition, lengthens generally in an axial direction.

11. An article according to any of claims 1 to 9, wherein the shape memory material is provided in the form of an elongate element which, upon shape transition, bends to generate a separation force.

12. An article according to claim 11, wherein the elongate element comprises a generally straight elongate portion.

13. An article according to any of claims 1 to 9, wherein the shape memory material is in the form of curved or bent element which is operative to uncurve, or unbend, at least partly to generate a separation force.

14. An article according to any of claims 1 to 13, wherein the shape memory material is provided in the form of an element which, upon shape transition, changes its cross sectional shape to generate a separation force.

15 An article according to any preceding claim, wherein the shape memory material forms, or forms part of, a releasable fastener for fastening together the first and second portions of the article.

16. An article according to claim 15, wherein the shape memory material forms an engagement or gripping portion of the releasable fastener.

17. An article comprising a releasable fastener for fastening together first and second portions of the article, the releasable fastener comprising at least one fastener engagement or gripping portion comprising shape memory material, the shape memory material being operative upon shape transition to change shape at least partly to release engagement of the fastener.

18. An article according to any preceding claim, wherein the shape material is a shape memory alloy.

19. An article according to claim 18, wherein the alloy includes nickel and titanium.

20. An article according to claim 18, wherein the alloy includes zinc, copper and aluminium.

21. An article according to claim 18, 19 or 20, wherein the shape memory material forms at least part of an element for holding and establishing an electrical connection to an electrical or electronic component, the shape memory alloy being operative to release engagement with the component upon shape transition.

22. An article according to claim 21, wherein the shape memory alloy forms part of a socket for receiving an integrated circuit.

23. An article according to any of claims 1 to 17, wherein the shape memory material is a shape memory polymer.

24. An article in which shape memory polymer is provided for assisting disassembly of the article, the shape memory polymer being operative upon shape transition to release a first portion of the article from a second portion.

25. An article according to claim 24, wherein the shape memory polymer forms, or forms part of, a releasable fastener for releasably fastening together the first and second portions.

26. An article according to claim 16, 17 or 25, or to any claim dependent thereon, wherein the releasable fastener comprises a jaw or which is displaceable to release the fastening.

27. An article according to any preceding claim, wherein the shape memory material is comprised in a strap or band which fits around the first and second portions to hold the portions in assembled relation, the shape memory material being operative upon shape transition to at least partly loosen the band or strap.

28. An article according to claim 27, wherein the shape memory material is operative upon shape transition to unwrap at least the end portions of the band or strap to release the band or strap.

29. An article according to claim 27 or 28, wherein the strap or band is made substantially entirely of shape memory material.

30. An article according to claim 16, 17 or 25, or to any claim dependent thereon, wherein the releasable fastener is in the form of an element for threadedly engaging a complementary fastener, the releasable fastener being operative upon transition to change shape to release threaded engagement with the complementary fastener.

31. An article according to claim 16, 17, or 25, or to any claim dependent thereon, wherein the releasable fastener comprises a female element for receiving a male element.

32 An article according to claim 31, wherein the shape memory material is operative upon shape transition to change the shape of an engagement surface of the female element to release a said male element received therein.

33. An article according to claim 32, wherein the shape memory material is operative to change the cross-sectional shape of at least the engagement surface of the female element from generally oval to generally round, in order to increase the minimum radial dimension of the cross-section and thereby release the male element.

34. An article according to claim 32 or 33, wherein the female element comprises a generally annular member, and wherein the shape memory material is operative upon shape transition to cause the female element to lengthen in a generally axial direction and concurrently to enlargen the inner diameter of the female member, thereby to release engagement with the male element, and to generate a separation force in the axial direction.

35. An article according to claim 16, 17 or 25, or to any claim dependent thereon, wherein the releasable fastener comprises a male element for engagement in a female element.

36. An article according to claim 35, wherein the male element is threaded.

37. An article according to claim 35 or 36, wherein the shape memory material is operative upon shape transition to change the cross-sectional shape of the shank of the screw to release engagement with the female member.

38. An article according to claim 37, wherein the shape memory material is operative to change the cross-sectional shape from generally oval to generally round, in order to decrease the maximum radial dimension of the cross-section, and thereby release engagement with the female member.

39. An article according to any preceding claim, comprising first and second elements of shape memory material, the second element having a different shape transition temperature from the first element, whereby sequential shape memory material assisted disassembly operations can be performed.

40. An article comprising first and second elements of shape memory material for assisting disassembly of the article, the first element having a different shape transition temperature from the second element, whereby sequential shape memory assisted disassembly operations can be performed.

41. An article comprising first and second elements of shape memory material, each element being operative upon shape transition to assist disassembly of respective portions of the article, the first and second elements being arranged or configured such that the first element can be triggered to change shape independently of the second element, whereby sequential shape memory material assisted disassembly operations can be performed.

42. A method of producing or assembling an article as defined in any preceding claim, the method comprising fitting at least one element of shape memory material in or to the article in such a manner that, upon shape transition, the shape memory material is operative to assist disassembly of the article.

43. A method of at least partially disassembling an article as defined in any of claims 1 to 40, the method comprising triggering shape transition of at least one element of shape memory material in or on the article, thereby to cause release and/or to urge separation of a first portion of the article relative to a second portion.

44. A method according to claim 43, comprising changing the temperature of the shape memory material to exceed, or drop below, the transition temperature of the material.

45. A method according to claim 44, wherein the temperature change is achieved by placing the article in a region of elevated or reduced temperature.

46. A method according to claim 44 or 45, comprising subjecting the article to a temperature gradient for triggering sequential disassembly at different temperatures.

47. A fastening element comprising shape memory polymer, the shape memory material being operative upon shape transition to change or relax its shape to release fastening engagement.

48. An element according to claim 45, wherein the element consists substantially entirely of shape memory polymer.

49. An element according to claim 47 or 48, comprising, at least under ambient temperature conditions, a threaded portion.

50. An element according to claim 47 or 48, wherein the element is in the form of a strap or band for wrapping around parts to be fastened.

51. A releasable fastener for releasably fastening a first part to a second part, the fastener comprising a first engagement region for engaging the first part and a second engagement region for engaging the second part, at least the first engagement region comprising shape memory material operative upon shape transition to change shape to release or relax the engagement.

52. A releasable fastener according to claim 51, wherein the first region comprises at least one jaw.

53. A releasable fastener according to claim 51 or 52, wherein the first region comprises a mouth in which the first part is received.

54. A releasable fastener according to claim 51, wherein the fastener comprises a tube or an annulus, one of the first and second engagement regions comprising a radially inner portion of the tube or annulus, and the other region comprising a radially outer portion of the tube or annulus.

55. A releasable fastener according to claim 51, 53 or 54, wherein the fastener has a generally oval cross sectional shape under ambient temperature conditions, and is operative to change shape to a generally round cross-section upon shape transition.

56. A releasable fastener according to any of claims 51 to 55, wherein the shape memory material comprises a shape memory alloy.

57. A releasable fastener according to claim 56, wherein the alloy includes titanium and nickel.

58. A releasable fastener according to claim 56, wherein the alloy includes copper, zinc and aluminium.

59. A releasable fastener according to any of claims 51 to 55, wherein the shape memory material is a shape memory polymer.

60. An article including shape memory material to assist disassembly of the article, substantially as hereinbefore described with reference to the accompanying drawings.

61. A defastener substantially as hereinbefore described with reference to FIGS. of the accompanying drawings.

62. A releasable fastener substantially as hereinbefore described with reference to FIGS. of the accompanying drawings.

63. A method of assembly or of disassembly of an article, the method being substantially as hereinbefore described with reference to the accompanying drawings.

64. Apparatus for triggering shape transition of shape memory material to assist disassembly of an article, the apparatus being substantially as hereinbefore described with reference to FIG. of the accompanying drawings.
